(19) United States
(12) Patent Application Publication
(10) Pub. No.: US 2025/0386308 A1
(43) Pub. Date: Dec. 18, 2025

(54) METHOD FOR TIME SYNCHRONIZATION VIA USER EQUIPMENT

(71) Applicant: ZaiNar, Inc., Redwood City, CA (US)

(72) Inventors: Babak Azimi-Sadjadi, Redwood City, CA (US); Philip A. Kratz, Redwood City, CA (US); Raquel Guerreiro Machado, Redwood City, CA (US); David Burgess, PRAIA DO PEDROGAO (PT)

(21) Appl. No.: 19/237,562

(22) Filed: Jun. 13, 2025

Related U.S. Application Data
(60) Provisional application No. 63/659,655, filed on Jun. 13, 2024.

(51) Int. Cl. H04W 56/00; H04L 5/00

(52) U.S. Cl. CPC H04W 56/001; H04L 5/0048

(57) ABSTRACT

A method includes: accessing a first time-of-arrival estimate for a reference signal transmitted from a reference device and received at a first node; accessing a second time-of-arrival estimate for the reference signal received at a second node; accessing a first time-of-flight estimate for the reference signal from the reference device to the first node based on a first distance between the reference device and the first node; accessing a second time-of-flight estimate for the reference signal from the reference device to the second node based on a second distance between the reference device and the second node; and calculating a time synchronization offset between the first node and the second node based on the first time-of-arrival estimate, the second time-of-arrival estimate, the first time-of-flight estimate, and the second time-of-flight estimate.

### CROSS-REFERENCE TO RELATED APPLICATIONS

This application claims the benefit of U.S. Provisional Application No. 63/659,655, filed on 13 Jun. 2024, which is incorporated in its entirety by this reference.

### TECHNICAL FIELD

This invention relates generally to the field of network-based positioning and, more specifically, to a new and useful method for time synchronization via user equipment within the field of network-based positioning.

### BRIEF DESCRIPTION OF THE FIGURES

FIGS. 1A and 1B are flowchart representations of a method;

FIG. 2 is a flowchart representation of one variation of the method; and

FIG. 3 is a flowchart representation of one variation of the method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Methods

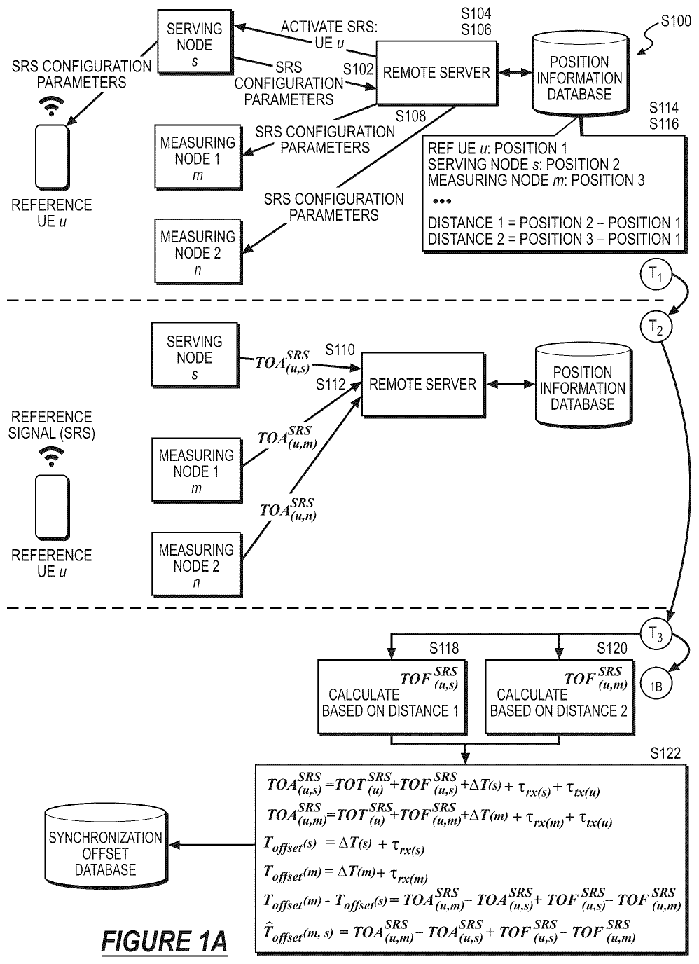

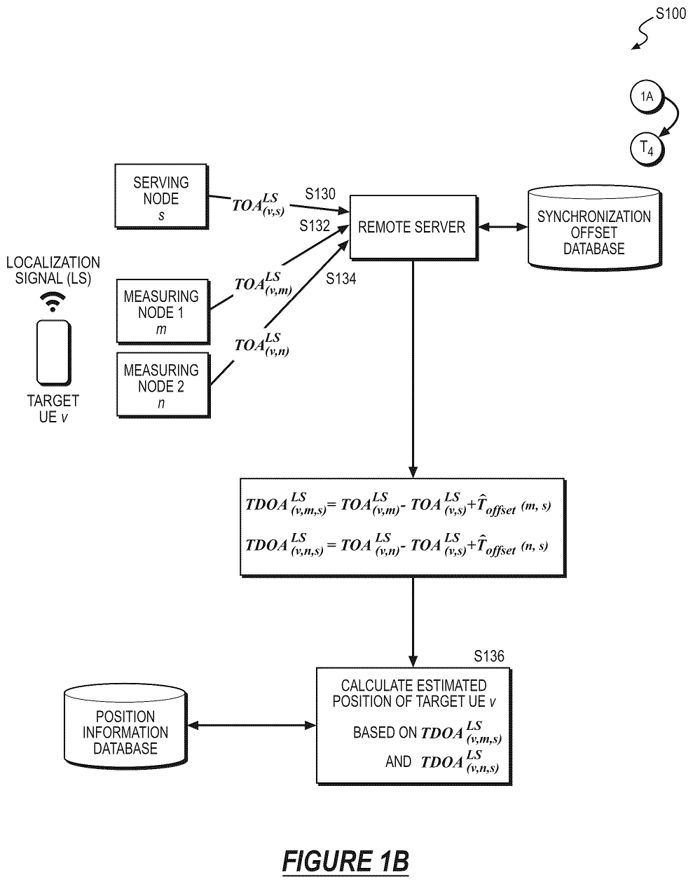

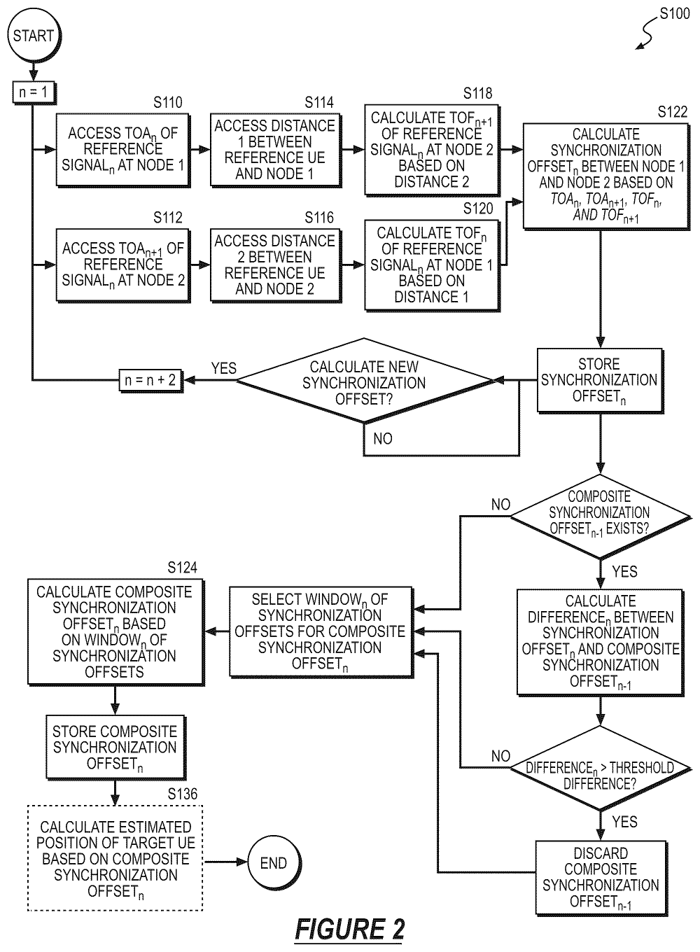

As shown in FIGS. 1A, 1B, and 2, a method S100 includes: accessing a first time-of-arrival estimate for a first reference signal received at a first node in Block S110, the reference signal transmitted from a first reference user equipment; accessing a second time-of-arrival estimate for the first reference signal received at a second node in Block S112; accessing a first distance between the first reference user equipment and the first node in Block S114; accessing a second distance between the first reference user equipment and the second node in Block S116; calculating a first time-of-flight estimate for the first reference signal from the first reference user equipment to the first node based on the first distance in Block S118; and calculating a second time-of-flight estimate for the first reference signal from the first reference user equipment to the second node based on the second distance in Block S120.

The method S100 also includes, in Block S122, calculating a first time synchronization offset between the first node and the second node based on: the first time-of-arrival estimate; the second time-of-arrival estimate; the first time-of-flight estimate; and the second time-of-flight estimate.

The method S100 further includes: accessing a third time-of-arrival estimate for a localization signal received at the first node in Block S130, the localization signal transmitted from a target user equipment; and accessing a fourth time-of-arrival estimate for the localization signal received at the second node in Block S132.

The method S100 also includes, in Block S136, calculating an estimated position, in a reference coordinate system, occupied by the target user equipment based on: the third time-of-arrival estimate; the fourth time-of-arrival estimate; and the first time synchronization offset.

### 1.1 Variation: Time Synchronization Via User Equipment Ensemble

As shown in FIGS. 1B, 2, and 3, one variation of the method S100 includes: accessing a first set of time-of-arrival estimates for a first set of signals transmitted from a set of devices and received at a first node in Block S140; accessing a second set of time-of-arrival estimates for a second set of signals transmitted from the set of devices and received at a second node in Block S142; calculating a first average time of arrival at the first node based on an average of the first set of time-of-arrival estimates in Block S144; calculating a second average time of arrival at the second node based on an average of the second set of time-of-arrival estimates in Block S146; and calculating a first time synchronization offset between the first node and the second node based on the first average time of arrival and the second average time of arrival in Block S148.

This variation of the method S100 also includes: accessing a first time-of-arrival estimate for a localization signal received at the first node in Block S130, the localization signal transmitted from a target device; accessing a second time-of-arrival estimate for the localization signal received at the second node in Block S132; and calculating an estimated position, in a reference coordinate system, occupied by the target device based on the first time-of-arrival estimate, the second time-of-arrival estimate, and the first time synchronization offset in Block S136.

### 1.2 Variation: Reference Device

As shown in FIGS. 1A, 1B, and 2, one variation of the method S100 includes: accessing a first time-of-arrival estimate for a reference signal received at a first node, the reference signal transmitted from a reference device in Block S110; accessing a second time-of-arrival estimate for the reference signal received at a second node in Block S112; accessing a first time-of-flight estimate for the reference signal from the reference device to the first node based on a first distance between the reference device and the first node in Block S118; and accessing a second time-of-flight estimate for the reference signal from the reference device to the second node based on a second distance between the reference device and the second node in Block S120.

This variation of the method S100 also includes, in Block S122, calculating a first time synchronization offset between the first node and the second node based on: the first time-of-arrival estimate; the second time-of-arrival estimate; the first time-of-flight estimate; and the second time-of-flight estimate.

### 1.3 Variation: Reference Signal Configuration and Transmission

As shown in FIGS. 1A, 1B, and 2, one variation of the method S100 includes, during a first time period: selecting a first set of configuration parameters for a first reference signal; instructing a first set of nodes to measure the first reference signal corresponding the first set of configuration parameters, the first set of nodes including a first node and a second node; and instructing a first device to broadcast the first reference signal according to the first set of configuration parameters.

This variation of the method S100 also includes, during a second time period succeeding the first time period: broadcasting the first reference signal from the first device positioned at a first location; receiving the first reference signal at the first node positioned at a second location; calculating a first time of arrival of the first reference signal at the first node in Block S110; receiving the first reference signal at the second node positioned at a third location; calculating a second time of arrival of the first reference signal at the second node in Block S112; calculating a first time of flight of the first reference signal from the first device to the first node based on a first distance between the first location and the second location in Block S118; calculating a second time of flight of the first reference signal from the first device to the second node based on a second distance between the first location and the third location in Block S120; calculating a first time synchronization offset for the second node relative to the first node based on the first time of arrival, the second time of arrival, the first time of flight, and the second time of flight in Block S122; and storing the first time synchronization offset in a database including a set of time synchronization offsets for pairs of nodes in the set of nodes.

### 2. Applications

Generally, a system—including or interfacing with a reference user equipment (e.g., a mobile phone, a cellular modem, a laptop computer including a wireless network interface device), a first node (e.g., a base station, a 5G gNodeB, a 5G transmission and reception point, a 5G radio unit), and a second node—can execute Blocks of the method S100: to transmit a reference signal (e.g., a sounding reference signal) from the reference user equipment; to receive the reference signal at the first node and the second node; and to calculate a time synchronization offset (or “time bias”) between the first node and the second node based on times-of-arrival of the reference signal at these nodes and known positions of the reference user equipment, the first node, and the second node.

For example, the system can execute Blocks of the method S100: to receive the reference signal at the first node and the second node; to calculate time-of-arrival estimates for the reference signal at these nodes; to calculate expected times of flight for the reference signal from the reference user equipment to the first node and the second node based on known positions of (and distances between) the reference user equipment, the first node, and the second node; and to calculate the time synchronization offset between the first node and the second node based on the time-of-arrival estimates and the expected times of flight for the reference signal.

Therefore, by calculating the time synchronization offset between the first node and the second node, the system can later: receive a subsequent signal (e.g., a localization signal)—transmitted by a target user equipment tracked by the first node and the second node—at these nodes; and adjust (or correct) a time difference of arrival for this signal received at these nodes based on the time synchronization offset, thereby improving accuracy of position estimation for the target device absent modification to network infrastructure and/or predefined communications standards (e.g., 5G communications standard).

More specifically, by correcting the time difference of arrival for the subsequent signal based on the time synchronization offset, the system can reduce localization error (e.g., from 30 meters of error based on 100 nanoseconds of nominal synchronization error between these nodes) on the order of one meter of error based on several nanoseconds of synchronization error.

The system can repeat these Blocks of the method S100 to calculate time synchronization offsets between other pairs of nodes based on known positions of the nodes and times of arrival of the reference signal at these nodes. Therefore, the system can execute Blocks of the method S100 to store these time synchronization offsets in a database in order to correct synchronization errors between each pair of nodes.

### 2.1 Variation: Time Synchronization Via User Equipment Ensemble

As described herein, the system executes Blocks of the method S100: to transmit a reference signal from a reference user equipment occupying a known position; and to calculate a time synchronization offset between pairs of nodes based on times of arrival—of the reference signal received at the pair of nodes—and known positions of the reference user equipment and these nodes.

However, rather than calculating the time synchronization offset based on a reference signal transmitted by a reference user equipment occupying a known position, the system can similarly execute Blocks of the method S100: to replace the reference user equipment with a set of user equipments exceeding a threshold quantity and distributed (e.g., uniformly distributed) at unknown positions in a geographic area; and to calculate the time synchronization offset between a pair of nodes based on communications signals transmitted by the user equipments absent information defining positions of these user equipments.

For example, the system can similarly execute Blocks of the method S100: to transmit signals (e.g., communications signals) from the set of user equipments; to calculate times of arrival of these signals received at a pair of nodes; to calculate a first average time of arrival of these signals at a first node in the pair of nodes; to calculate a second average time of arrival of these signals at a second node in the pair of nodes; and to calculate a time synchronization offset between the first node and the second node based on the first average time of arrival and the second average time of arrival. Therefore, the system can calculate the time synchronization offset between the pair of nodes based on communications signals transmitted by the set of user equipments absent additional burden to a communication network (e.g., due to reference signals broadcast from reference user equipments).

### 2.2 Variation: Reference User Equipment Based on Confidence

As described herein, the system executes the method S100: to transmit a reference signal from a reference user equipment occupying a known position in a reference coordinate system; to receive the reference signal at a first node and a second node; to calculate time-of-arrival estimates for the reference signal at these nodes; to calculate expected times of flight for the reference signal from the reference user equipment to the first node and the second node based on known position of (and distances between) the reference user equipment, the first node, and the second node in the reference coordinate system; and to calculate the time synchronization offset between the first node and the second node based on the time-of-arrival estimates and the expected times of flight for the reference signal.

However, the system can similarly execute Blocks of the method S100 to: access (or calculate) an estimated position of a target user equipment in the reference coordinate system; to identify (or derive) a confidence score for the estimated position of the target user equipment; and designate the target user equipment as a reference user equipment in response to the confidence score exceeding a threshold confidence score (e.g., 90%, 95%). The system can then execute Blocks of the method S100: to transmit a reference signal from the target user equipment designated as the reference user equipment; to receive the reference signal at a first node and a second node; and to calculate a time synchronization offset between the first node and the second node based on times of arrival of the reference signal received at these nodes and positions of the target user equipment, the first node, and the second node.

### 3. System

Generally, as shown in FIGS. 1A and 1B, the system can include and/or interface with: a set of nodes (e.g., base stations, anchors, 5G gNodeBs, 5G radio units, 5G transmission and reception points, 4G-LTE eNodeBs); and a set of devices (e.g., 5G user equipments, mobile phones, cellular modems, a laptop computer including a wireless network interface device, 4G-LTE user equipments). Additionally, the system can include and/or interface with a remote computer system (e.g., a remote server).

In one example, the set of nodes can include a first gNodeB and a first transmission and reception point in a set of transmission and reception points. The first transmission and reception point includes a set of geographically co-located antennas (e.g., an antenna array(s) including a set of antenna elements with (or without) distinct polarization, multiple input multiple output (MIMO) arrays, beamforming arrays) that support transmission point and/or reception point functionality. Additionally, the first transmission and reception point can include a remote radio head.

In this example, the first gNodeB serves the set of transmission and reception points, including the first transmission and reception point.

In one implementation, the set of devices can include a first reference user equipment (or “UE”) (e.g., a mobile phone, a cellular modem, a laptop computer including a wireless network interface device). For example, the first reference user equipment is arranged at (e.g., occupying) a first position (e.g., a first known position) in a reference coordinate system (e.g., a two-dimensional coordinate system, a three-dimensional coordinate system).

In this implementation, the first reference user equipment can transmit (e.g., broadcast) a reference signal (e.g., a sounding reference signal).

In another implementation, a first node in the set of nodes: receives the reference signal broadcast from the first reference user equipment; calculates a first time of arrival (or “TOA”) estimate for the reference signal received at the first node; and transmits the first time-of-arrival estimate to the remote computer system. The first node is occupying a second position (e.g., a second known position) in the reference coordinate system.

In another implementation, a second node in the set of nodes executes the foregoing methods and techniques: to receive the reference signal broadcast from the first reference user equipment; to calculate a second time-of-arrival estimate for the reference signal received at the second node; and to transmit the second time-of-arrival estimate to the remote computer system. The second node is positioned at a third position (e.g., a third known position) in the reference coordinate system.

In another implementation, the remote computer system (e.g., a location management function executing in the remote server): accesses the first time-of-arrival estimate for the reference signal received at the first node; accesses the second time-of-arrival estimate for the reference signal received at the second node; calculates a first time of flight (or “TOF”) estimate for the reference signal from the first reference user equipment to the first node based on a first distance between the first reference user equipment and the first node (e.g., a first distance between the first position and the second position); and calculates a second time-of-flight estimate for the reference signal from the first reference user equipment to the second node based on a second distance between the first reference user equipment and the second node (e.g., a second distance between the first position and the third position).

In this implementation, the remote computer system calculates a first time synchronization offset-between the first node and the second node-based on the first time-of-arrival estimate, the second time-of-arrival estimate, the first time-of-flight estimate, and the second time-of-flight estimate.

The system can repeat the foregoing methods and techniques to calculate time synchronization offsets between other pairs of nodes in the set of nodes based on time-of-arrival estimates for the reference signal received by these nodes and times of flight estimates of the reference signal from the reference user equipment to these nodes.

Therefore, the system can reduce synchronization error between pairs of nodes in the set of nodes in order to improve accuracy of network-based positioning techniques absent modification to network infrastructure and/or predefined communications standards (e.g., the 5G communications standard).

In another implementation, the set of devices can include a set of reference user equipments. The system can repeat the foregoing methods and techniques for each reference user equipment in the set of reference user equipments to calculate time synchronization offsets between pairs of nodes in the set of nodes based on time-of-arrival estimates of a reference signal broadcast by the reference user equipment and received by these nodes.

### 4. Node and Reference User Equipment Positions

Generally, the system can identify (or detect) positions occupied by a node and/or a reference user equipment in the reference coordinate system.

In one implementation, the system: accesses a first set of position information representing a first position occupied by a first node—in the set of nodes—in the reference coordinate system; and identifies the first position occupied by the first node based on the first set of position information.

In one example, the system accesses the first set of position information specifying a first set of coordinates, in the reference coordinate system, representing the first position occupied by the first node based on geographic survey measurements of the first node.

In another example, the system accesses the first set of position information specifying sets of coordinates, in the reference coordinate system, occupied by the first node at each time interval in a set of time intervals. In this example, the system identifies the first position of the first node based on the sets of coordinates (e.g., an average of the sets of coordinates, a centroid of the sets of coordinates).

The system can execute the foregoing methods and techniques for each node in the set of nodes: to access a set of position information representing a position occupied by the node in the reference coordinate system; and to identify (or detect) the position occupied by the node based on the set of position information.

In another implementation, the system executes similar methods and techniques described above: to access a second set of position information representing a second position occupied by a reference user equipment in the reference coordinate system; and identifies the second position occupied by the reference user equipment based on the second set of position information.

In one example, the system: accesses the second set of position information specifying a set of coordinates, in the reference coordinate system, representing the second position occupied by the reference user equipment based on geographic survey measurements of the reference user equipment.

In another example, the system: accesses a first set of coordinates, in the reference coordinate system, representing a first position occupied by the reference user equipment at a first time; accesses a second set of coordinates, in the reference coordinate system, representing a second position occupied by the reference user equipment at a second time; and calculates a position occupied by the reference user equipment based on sets of coordinates including the first set of coordinates and the second set of coordinates (e.g., a centroid of the sets of coordinates sets of coordinates, an average of the sets of coordinates).

Therefore, by identifying positions occupied by the set of nodes and the reference user equipment, the system can: calculate a distance between the reference user equipment and a node in the set of nodes based on these positions; and calculate a time-of-flight estimate for a reference signal broadcast from the reference user equipment to the node in order to derive time synchronization offsets between pairs of nodes in the set of nodes absent modification to hardware of the node and the reference user equipment and/or absent modification to predefined communications standards (e.g., the 5G communications standard).

The system can execute the foregoing methods and techniques for each reference user equipment in the set of reference user equipments: to access a set of position information representing a position occupied by the reference user equipment in the reference coordinate system; and to identify (or detect) the position occupied by the reference user equipment based on the set of position information.

### 4.1 Distances

The method S100 includes: accessing a first distance between the first reference user equipment and the first node in Block S114; and accessing a second distance between the first reference user equipment and the second node in Block S116.

Generally, in Blocks S114 and S116, the system can access a distance between a reference user equipment and a node in the set of nodes.

In one implementation, the system: accesses a first set of position information representing a first position occupied by a first node, in the set of nodes, in a reference coordinate system; accesses a second set of position information representing a second position occupied by a first reference user equipment in the reference coordinate system; and calculates a first distance-between the first reference user equipment and the first node-based on a difference between the first position and the second position in Block S114.

For example, the system can: identify the first position of the first node based on the first set of position information; identify the second position of the first reference user equipment; and calculate the first distance between the first position and the second position.

In response to calculating the first distance between the first reference user equipment and the first node, the system can store the first distance in a first data repository (e.g., a database).

The system executes the foregoing methods and techniques for each node in the set of nodes: to access a set of position information representing a position occupied by the node in the reference coordinate system; to access the second set of position information representing the second position occupied by the first reference user equipment in the reference coordinate system; to calculate a distance-between the first reference user equipment and the node-based on a difference between the position occupied by the node and the second position occupied by the first reference user equipment; and to store the distance in the first data repository.

For example, the system can: access a third set of position information representing a third position occupied by a second node, in the set of nodes, in a reference coordinate system; access the second set of position information representing the second position occupied by the first reference user equipment in the reference coordinate system; calculate a second distance-between the first reference user equipment and the second node-based on a difference between the third position and the second position; and store the second distance in the first data repository.

Additionally, the system can repeat the foregoing methods and techniques for each reference user equipment in the set of reference user equipments to calculate a distance-between the reference user equipment and a node in the set of nodes-based on a difference between a position occupied by the node and a position occupied by the reference user equipment; and to store the distance in the first data repository.

### 5. Reference Signal Configuration

The method S100 includes: receiving a first message from the first node, the first message specifying a set of configuration parameters for the first reference signal in Block S102; selecting a set of nodes for the first reference signal, the first set of nodes including the first node and the second node in Block S104; generating a second message specifying the set of configuration parameters in Block S106; and transmitting the second message to the second node in Block S108.

Generally, in Blocks S102, S104, S106, and S108, the system can: instruct a node (e.g., a serving node) in the set of nodes to schedule a reference user equipment to activate a reference signal; select a set of configuration parameters for the reference signal; and instruct a subset of nodes (e.g., the serving node, a subset of measuring nodes in the set of nodes) in the set of nodes to receive the reference signal transmitted according to the set of configuration parameters.

In one implementation, during a first time period (e.g., a configuration period), the remote computer system: identifies a first reference user equipment in the set of devices to activate a first reference signal; identifies a first node in the set of nodes that serves the first reference user equipment; and instructs the first node to schedule the first reference user equipment to activate the first reference signal.

In this implementation, the first node selects a first set of configuration parameters for the first reference signal. For example, the first node can select the first set of configuration parameters—for the first reference signal—specifying: a first bandwidth; a first subcarrier spacing value; a first set of antenna ports; a first transmit power; and/or a first frequency position; etc.

In response to selecting the first set of configuration parameters, the first node: generates a first message indicating the first set of configuration parameters; and transmits the message to the remote computer system.

Additionally, the first node instructs (e.g., schedules) the first reference user equipment to broadcast the first reference signal according to the first set of configuration parameters. For example, the first node can: generate a second message (e.g., a synchronization signal block) specifying the first set of configuration parameters and a first schedule (e.g., an absolute time, a relative time offset) for transmission of the first reference signal; and transmit the second message to the first reference user equipment.

In another implementation, the remote computer system: receives the first message—specifying the first set of configuration parameters for the first reference signal—from the first node in Block S102; and selects a first subset of nodes, in the set of nodes, for the first reference signal in Block S104.

More specifically, the remote computer system can select the first subset of nodes based on positions (e.g., proximal the first reference user equipment, within line of sight of the first reference user equipment) of nodes in the first subset of nodes. For example, the remote computer system can select the first subset of nodes including: the first node that serves the first reference user equipment; a second node proximal the first reference user equipment; and a third node proximal the first reference user equipment.

In response to selecting the first subset of nodes, the remote computer system instructs the first subset of nodes to measure the first reference signal according to the first set of configuration parameters.

More specifically, for each node in the first subset of nodes, the remote computer system can: generate a message specifying a transaction identifier for the node and the first set of configuration parameters in Block S106; and transmit the message to the node in Block S108.

For example, the remote computer system can: generate a third message specifying a first transaction identifier for the first node and the first set of configuration parameters; and transmit the third message to the first node.

Additionally, the remote computer system can: generate a fourth message specifying a second transaction identifier for the second node and the first set of configuration parameters; and transmit the fourth message to the second node.

### 6. Reference Signal Transmission and Measurement

Generally, a node in the first subset of nodes can: receive a message from the remote computer system specifying a set of configuration parameters for a reference signal and a transaction identifier for the node; measure (and record) the reference signal transmitted from the reference user equipment according to the set of configuration parameters; calculate a time-of-arrival estimate for the reference signal received at the node; and transmit the time-of-arrival estimate to the remote computer system.

In one implementation, during a second time period (e.g., a measurement period) succeeding the first time period, the first reference user equipment transmits (e.g., broadcasts) the first reference signal according to the first set of configuration parameters.

For example, in response to receiving the second message specifying the first set of configuration parameters and the first schedule, the first reference user equipment can broadcast the first reference signal exhibiting a first set of characteristics—corresponding to the first set of configuration parameters—at a first time according to the first schedule.

In another implementation, the first node: receives the first reference signal transmitted from the first reference user equipment; and calculates a first time-of-arrival estimate for the first reference signal received at the first node.

More specifically, the first node can: detect the first reference signal exhibiting the first set of characteristics corresponding to the first set of configuration parameters; and record the first time-of-arrival estimate for the first reference signal in association with the first transaction identifier.

Therefore, by detecting the first reference signal exhibiting the first set of characteristics corresponding to the first set of configuration parameters, the first node can (implicitly) identify the first reference signal based on the first set of characteristics rather than based on a unique identifier associated with the first reference signal, thereby enabling the system to derive time synchronization offsets between pairs of nodes based on the first reference signal in compliance with predefined communications standards (e.g., the 5G communications standard).

In another implementation, the first node transmits the first time-of-arrival estimate to the remote computer system.

For example, in response to calculating the first time-of-arrival estimate, the first node can: generate a message specifying the first transaction identifier for the first node and the first time-of-arrival estimate; and transmit the message to the remote computer system.

The system can repeat the foregoing methods and techniques for each node in the first subset of nodes: to receive (or detect) the first reference signal exhibiting the first set of characteristics corresponding to the first set of configuration parameters; to calculate a time-of-arrival estimate for the first reference signal received at the node; and to transmit the time-of-arrival estimate to the remote computer system.

For example, the second node can: detect the first reference signal exhibiting the first set of characteristics corresponding to the first set of configuration parameters; calculate a second time-of-arrival estimate for the first reference signal received at the second node; generate a message specifying the second transaction identifier and the second time-of-arrival estimate; and transmit the message to the remote computer system.

### 6.1 Time-of-Arrival Aggregation

The method S100 includes: accessing a first time-of-arrival estimate for a first reference signal received at a first node in Block S110, the reference signal transmitted from a first reference user equipment; and accessing a second time-of-arrival estimate for the first reference signal received at a second node in Block S112.

Generally, in Blocks S110 and S112, the system can access a set of time-of-arrival estimates for a reference signal received at a subset of nodes.

In one implementation, during a third time period (e.g., a calculation period) succeeding the second time period, the remote computer system receives a set of messages from the first subset of nodes specifying a set of transaction identifiers and a set of time-of-arrival estimates for the first reference signal received at the first subset of nodes according to the first set of configuration parameters.

In this implementation, the remote computer system associates a particular time-of-arrival estimate in the set of time-of-arrival estimates—and a particular node in the first subset of nodes—with the first reference signal based on a transaction identifier in the set of transaction identifiers.

For example, the remote computer system can: receive a first message specifying the first transaction identifier for the first node and the first time-of-arrival estimate for the first reference signal received at the first node in Block S110; associate the first time-of-arrival estimate with the first reference signal and the first node based on the first transaction identifier; receive a second message specifying the second transaction identifier for the second node and the second time-of-arrival estimate for the first reference signal received at the second node in Block S112; and associate the second time-of-arrival estimate with the first reference signal and the second node based on the second transaction identifier.

Therefore, the system can aggregate time-of-arrival estimates for the first reference signal received at the first subset of nodes in order to derive time synchronization offsets between pairs of nodes in the first subset of nodes based on these time-of-arrival estimates.

### 7. Time Synchronization Offset Calculation

The method S100 includes: calculating a first time-of-flight estimate for the first reference signal from the first reference user equipment to the first node based on the first distance in Block S118; and calculating a second time-of-flight estimate for the first reference signal from the first reference user equipment to the second node based on the second distance in Block S120.

Block S122 of the method S100 recites calculating a first time synchronization offset between the first node and the second node based on: the first time-of-arrival estimate; the second time-of-arrival estimate; the first time of flight; and the second time of flight.

Generally, in Blocks S114, S118, S116, S120, and S122, the system can calculate a time synchronization offset between a pair of nodes-such as the first node s and the second node m-based on times of arrival estimates for a reference signal (e.g., the first reference signal) transmitted by one reference user equipment (e.g., the first reference user equipment u) and received at these nodes.

In one implementation, the remote computer system: accesses a first time-of-flight estimate for the first reference signal from the first reference user equipment to the first node based on the first distance between the first reference user equipment u and the first node s in Block S118; and accesses a second time-of-flight estimate for the first reference signal from the first reference user equipment to the second node based on the second distance between the first reference user equipment u and the second node m in Block S120.

More specifically, the remote computer system can: access the first distance between the first reference user equipment and the first node s; and access the second distance between the first reference user equipment and the second node m. For example, the remote computer system can retrieve the first distance and the second distance from the first data repository.

The remote computer system can then: calculate a first time-of-flight estimate

$${TOF}_{( u , s )}^{SRS}$$

for the first reference signal from the first reference user equipment u to the first node s based on the first distance; and calculate a second time-of-flight estimate

$${TOF}_{( u , s )}^{SRS}$$

for the first reference signal from the first reference user equipment u to the second node m based on the second distance.

In another implementation, in Block S122, the remote computer system calculates a first time synchronization offset—for the second node relative to the first node—based on: the first time-of-arrival estimate for the first reference signal received at the first node s; the second time-of-arrival estimate for the first reference signal received at the second node m; the first time-of-flight estimate

$${TOF}_{( u , s )}^{SRS}$$

for the first reference signal from the first reference user equipment u to the first node s; and the second time-of-flight estimate

$${TOF}_{( u , m )}^{SRS}$$

for the first reference signal from the first reference user equipment u to the second node m.

Additionally, the remote computer system can store the first time synchronization offset in a second data repository (e.g., a second database).

More specifically, the remote computer system can characterize the first time-of-arrival estimate

$${TOA}_{( u , s )}^{SRS}$$

as.

$${TOA}_{( u , s )}^{SRS} = {TOT}_{( u )}^{SRS} + {TOF}_{( u , s )}^{SRS} + Δ T ( s ) + {τ}_{rx ( s )} + {τ}_{tx ( u )}$$

In this implementation:

$${TOT}_{( u )}^{SRS}$$

defines a time or transmission of the first reference signal at the first reference user equipment u; τᵣₓ₍ₛ₎ defines a first delay associated with a receive chain of the first node s; ΔT(s) defines a first time offset for the first node s; and τₜₓ₍ᵤ₎ defines a second delay associated with a transmit chain of the first reference user equipment u.

The remote computer system can characterize the second time-of-arrival estimate

$$T 0 {A}_{( u ,}^{S R S}$$

as:

$${TOA}_{( u , s )}^{SRS} = {TOT}_{( u )}^{SRS} + {TOF}_{( u , s )}^{SRS} + Δ T ( m ) + {τ}_{rx ( s )} + {τ}_{tx ( u )}$$

In this implementation: ΔT(m) defines a second time offset for the second node m; and τᵣₓ₍ₘ₎ defines a third delay associated with a receive chain of the second node m.

Because the first delay τᵣₓ₍ₛ₎ associated with the receive chain of the first node s is constant, the system can combine the first delay τᵣₓ₍ₛ₎ and the first time offset ΔT(s) into a first term T_{offset(s)} representing a time offset of the first node s relative to a target reference, wherein:

$${T}_{offset} ( s ) = Δ T ( s ) + {τ}_{rx ( s )}$$

Similarly, because the third delay τᵣₓ₍ₘ₎ associated with the receive chain of the second node m is constant, the system can combine the third delay τᵣₓ₍ₘ₎ and the second time offset ΔT(m) into a first term T_{offset(m)} representing a time offset of the second node m relative to the target reference, wherein:

$${T}_{offset} ( m ) = Δ T ( m ) + {τ}_{rx ( m )}$$

Additionally, because (only) a relative time offset between nodes (e.g., the first node s and the second node m) is of interest, the system can omit a term representing the global time reference from the foregoing equations.

Accordingly, the remote computer system can characterize the first time synchronization offset \hat{T}_{offset}(m,s) between the second node m and the first node s as:

$${T}_{offset} ( m ) - {T}_{offset} ( s ) = {TOA}_{( u , m )}^{SRS} - {TOA}_{( u , s )}^{SRS} + {TOF}_{( u , s )}^{SRS} - {TOF}_{( u , m )}^{SRS}$$

$${\hat{T}}_{offset} ( m , s ) = {TOA}_{( u , m )}^{SRS} - {TOA}_{( u , s )}^{SRS} + {TOF}_{( u , s )}^{SRS} - {TOF}_{( u , m )}^{sRS}$$

Therefore, by calculating the first time synchronization offset between the second node and the first node, the system can adjust (or correct) a time difference of arrival (or “TDOA”)—based on the first time synchronization offset—for a subsequent signal transmitted by a target device (e.g., a user equipment) tracked by the first node and the second node in order to increase accuracy of localization of the target device by the first node and the second node.

### 7.1 Additional Time Synchronization Offset Calculations

The system can execute the foregoing methods and techniques to calculate a time synchronization offset between other pairs of nodes based on time-of-arrival estimates for the first reference signal received at these nodes.

In one example, the system executes the foregoing methods and techniques: to access a third time-of-arrival estimate

$${TOA}_{( u , n )}^{SRS}$$

for the first reference signal received at a third node n in the first subset of nodes; to access a third distance between the first reference user equipment and the third node; to calculate a third time-of-flight estimate for the first reference signal from the first reference user equipment to the third node based on the third distance; to calculate a second time synchronization offset \hat{T}_{offset}(n,s)—for the third node relative to the first node-based on the first time-of-arrival estimate

$${TOA}_{( u , s )}^{SRS} ,$$

the third time-of-arrival estimate

$${TOA}_{( u , n )}^{SRS} ,$$

the first time-of-flight estimate, and the third time-of-flight estimate; and to store the second time synchronization offset \hat{T}_{offset}(n,s) in the second data repository.

In another example, the system executes the foregoing methods and techniques: to calculate a third time synchronization offset—for the third node relative to the second node—based on the second time-of-arrival estimate, the third time-of-arrival estimate, the second time-of-flight estimate, and the third time-of-flight estimate; and to store the third time synchronization offset in the second data repository.

### 8. Target Device Position Estimation

The method S100 includes: accessing a third time-of-arrival estimate for a localization signal received at the first node, the localization signal transmitted from a target user equipment in Block S130; accessing a fourth time-of-arrival estimate for the localization signal received at the second node in Block S132; calculating an estimated position, in a reference coordinate system, occupied by the target user equipment based on the third time-of-arrival estimate, the fourth time-of-arrival estimate, and the first time synchronization offset in Block S136.

Generally, in Blocks S130, S132, S134, and S136, the system can: receive a signal (e.g., a localization signal)—transmitted by a target device (e.g., a target user equipment)—at a subset of nodes; access time-of-arrival estimates for the signal received at these nodes; and calculate an estimated position of the target device in a reference coordinate system based on these time-of-arrival estimates and time synchronization offsets between pairs of nodes in the subset of nodes.

In one implementation, the first node: receives a localization signal transmitted by a target device; calculates a first time-of-arrival estimate for the localization signal received at the first node; and transmits the first time-of-arrival estimate to the remote computer system.

For example, the first node can execute similar methods and techniques described above: to generate a message specifying the first time-of-arrival estimate; and to transmit the message to the remote computer system.

In this implementation, the second node executes the foregoing methods and techniques: to receive the localization signal transmitted by the target device; to calculate a second time-of-arrival estimate for the localization signal received at the second node; and to transmit the second time-of-arrival estimate to the remote computer system.

Additionally, the third node can execute the foregoing methods and techniques: to receive the localization signal transmitted by the target device; to calculate a third time-of-arrival estimate for the localization signal received at the third node; and to transmit the third time-of-arrival estimate to the remote computer system.

In another implementation, the remote computer system: accesses the first time-of-arrival estimate for the localization signal received at the first node in Block S130; accesses the second time-of-arrival estimate for the localization signal received at the second node in Block S132; and accesses the third time-of-arrival estimate for the localization signal received at the third node in Block S136.

In another implementation, the remote computer system: accesses the first time synchronization offset between the first node and the second node (e.g., from the second data repository); accesses the second time synchronization offset between the first node and the third node; and accesses the third time synchronization offset between the second node and the third node.

In this implementation, in Block S136, the remote computer system calculates an estimated position—in the reference coordinate system—of the target device based on: the first time-of-arrival estimate; the second time-of-arrival estimate; the third time-of-arrival estimate; the first time synchronization offset; the second time synchronization offset; and/or the third time synchronization offset.

For example, the remote computer system can calculate a first time difference of arrival

$${TDOA}_{( v , m , s )}^{LS}$$

for the localization signal—transmitted by the target device v and received at the first node s and the second node m—based on: the first time-of-arrival estimate

$${TOA}_{( v , m )}^{LS} ;$$

the second time-of-arrival estimate

$${TOA}_{( v , s )}^{LS} ;$$

and the first time synchronization offset \hat{T}_{offset}(m,s), wherein:

$${TDOA}_{( v , m , s )}^{LS} = {TOA}_{( v , m )}^{LS} - {TOA}_{( v , s )}^{LS} + {\hat{T}}_{offset} ( m , s )$$

In this example, the remote computer system can execute the foregoing methods and techniques to calculate a second time difference of arrival

$${TDOA}_{( v , n , s )}^{LS}$$

for the localization signal received at the first node s and the third node n based on: the first time-of-arrival estimate

$${TOA}_{( v , s )}^{LS} ;$$

the third time-ot-arrival estimate

$${TOA}_{( v , n )}^{LS} ;$$

and the second time synchronization offset \hat{T}_{offset}(n,s), wherein:

$${TDOA}_{( v , n , s )}^{LS} = {TOA}_{( v , n )}^{LS} - {TOA}_{( v , s )}^{LS} + {\hat{T}}_{offset} ( n , s )$$

Additionally or alternatively, the remote computer system can execute the foregoing methods and techniques to calculate a third time difference of arrival for the localization signal received at the second node and the third node based on: the second time-of-arrival estimate; the third time-of-arrival estimate; and the third time synchronization offset.

In this example, the remote computer system can then calculate the estimated position—in the reference coordinate system—occupied by the target device based on: the first time difference of arrival; the second time difference of arrival; and/or the third time difference of arrival.

Therefore, the system can calculate the estimate position of the target device based on these time synchronization offsets in order: to reduce error in time synchronization of local clocks in these nodes; and to improve accuracy of the estimated position of the target device.

### 9. Composite Time Synchronization Offset

The method S100 includes: accessing a third time-of-arrival estimate for a second reference signal received at the first node, the second reference signal transmitted from the first reference user equipment in Block S110; and accessing a fourth time-of-arrival estimate for the second reference signal received at the second node in Block S112.

Block S122 of the method S100 recites calculating a second time synchronization offset between the first node and the second node based on: the third time-of-arrival estimate; the fourth time-of-arrival estimate; a third time-of-flight estimate for the second reference signal from the first reference user equipment to the first node based on the first distance between the first reference user equipment and the first node; and a fourth time-of-flight estimate for the second reference signal from the first reference user equipment to the second node based on the second distance between the first reference user equipment and the second node.

Block S124 of the method S100 recites calculating a first composite time synchronization offset between the first node and the second node based on the first time synchronization offset and the second time synchronization offset.

Generally, as shown in FIG. 2 and in Blocks S110, S112, S114, S122, and S124, the system can: calculate (or access) a set (or “window”) of time synchronization offsets (e.g., including a first time synchronization offset and a second time synchronization offset) between the first node and the second node based on a set of reference signals transmitted from a reference user equipment(s); and calculate a composite time synchronization offset-between the first node and the second node-based on the set of time synchronization offsets.

In one implementation, the remote computer system executes the foregoing methods and techniques: to access a third time-of-arrival estimate for a second reference signal transmitted from the first reference user equipment and received at the first node in Block S110; to access a fourth time-of-arrival estimate for the second reference signal received at the second node in Block S112; to calculate (or access) a third time-of-flight estimate for the second reference signal from the first reference user equipment to the first node based on the first distance between the first reference user equipment and the first node in Block S118; and to calculate (or access) a fourth time-of-flight estimate for the second reference signal from the first reference user equipment to the second node based on the second distance between the first reference user equipment and the second node in Block S120.

In this implementation, in Block S122, the remote computer system executes the foregoing methods and techniques to calculate a second time synchronization offset between the first node and the second node based on: the third time-of-arrival estimate; the fourth time-of-arrival estimate; the third time-of-flight estimate; and the fourth time-of-flight estimate. Additionally, the remote computer system can store the second time synchronization offset in the second data repository.

In another implementation, the remote computer system accesses a first set of time synchronization offsets between the first node and the second node. For example, the remote computer system can access the first set of time synchronization offsets—including the first time synchronization offset and the second time synchronization offset between the first node and the second node—from the second data repository.

In this implementation, in Block S124, the remote computer system calculates a first composite time synchronization offset between the first node and the second node based on the first set of time synchronization offsets.

In one example, the remote computer system calculates the first composite time synchronization offset based on an average (e.g., a simple average) of the first set of time synchronization offsets.

In another example, the remote computer system calculates the composite time synchronization offset based on a median (e.g., a median filter) of the first set of time synchronization offsets.

In another implementation, the remote computer system calculates an estimated position, in the reference coordinate system, occupied by a target device based on the first composite time synchronization offset in Block S136.

More specifically, the remote computer system can execute the foregoing methods and techniques: to access a first time-of-arrival estimate for a localization signal transmitted from a target device and received at the first node; to access a second time-of-arrival estimate for the localization signal received at the second node; and to calculate the estimated position of the target device based on the first time-of-arrival estimate, the second time-of-arrival estimate, and the first composite time synchronization offset.

For example, the remote computer system can execute the foregoing methods and techniques: to calculate a time difference of arrival for the localization signal received at the first node and the second node based on the first time-of-arrival estimate and the second time-of-arrival estimate; and calculate the estimated position of the target device based on the time difference of arrival and the first composite time synchronization offset.

### 9.1 Composite Time Synchronization Offset Recalculation

In one variation, the system executes the foregoing methods and techniques to calculate a third time synchronization offset between the first node and the second node based on time-of-arrival estimates for a third reference signal transmitted from the first reference user equipment and received at the first node and the second node.

More specifically, the remote computer system can calculate the third time synchronization offset between the first node and the second node based on: a fifth time-of-arrival estimate for the third reference signal received at the first node; a sixth time-of-arrival estimate for the third reference signal received at the second node; a fifth time-of-flight estimate for the third reference signal from the first reference user equipment to the first node; and a sixth time-of-flight estimate for the third reference signal from the first reference user equipment to the second node.

In this variation, the remote computer system calculates a difference between the third time synchronization offset and the first composite time synchronization offset. In response to the difference-between the third time synchronization offset and the first composite time synchronization offset-exceeding a threshold difference (e.g., 5%, 15%), the remote computer system: discards the first composite time synchronization offset; accesses a second set of time synchronization offsets between the first node and the second node; and calculates a second composite time synchronization offset between the first node and the second node based on the second set of time synchronization offsets in Block S124.

For example, the remote computer system can select the second set of time synchronization offsets: including the third time synchronization offset; and excluding the first time synchronization offset and the second time synchronization offset.

Therefore, the system can: detect a sudden change in a time synchronization offset between the first node and the second node (e.g., relative to a composite time synchronization offset between the first node and the second node), such as in response to a status change (e.g., a hardware reset) of the first node or the second node; and calculate a new composite time synchronization offset between the first node and the second node based on new measurements recorded after the status change (rather than historical measurements recorded prior to the status change).

Additionally, in response to the difference-between the third time synchronization offset and the first composite time synchronization offset-exceeding the predefined threshold difference, the system repeats the foregoing methods and techniques for each other node in the set (or a subset) of nodes: to discard an extant composite time synchronization offset between the first node (or the second node) and the node; and to calculate a new composite time synchronization offset based on a subsequent set of time synchronization offsets between the first node (or the second node) and the node.

### 9.2 Additional Reference User Equipments

In another variation, the system can include a set of reference user equipments including the first reference user equipment and a second reference user equipment.

In this variation, the remote computer system executes the foregoing methods and techniques: to instruct a third node (e.g., a second serving node) in the set of nodes to schedule the second reference user equipment to activate a second reference signal; to select a second set of configuration parameters for the second reference signal; to instruct a second subset of nodes—including the first node and the second node—in the set of nodes to measure the second reference signal according to the second set of configuration parameters; and to broadcast the second reference signal according to second set of configuration parameters.

The remote computer system then executes the foregoing methods and techniques: to access a third time-of-arrival estimate for the second reference signal transmitted from the second reference user equipment and received at the first node; to access a fourth time-of-arrival estimate for the reference signal received at the second node; to calculate a third time-of-flight estimate for the reference signal from the second reference user equipment to the first node based on a third distance between the second reference user equipment and the first node; and to calculate a fourth time-of-flight estimate for the reference signal from the second reference user equipment to the second node based on the fourth distance between the second reference user equipment and the second node.

In this variation, the remote computer system executes the foregoing methods and techniques to calculate a second time synchronization offset between the first node and the second node based on: the third time-of-arrival estimate; the fourth time-of-arrival estimate; the third time-of-flight estimate; and the fourth time-of-flight estimate. Additionally, the remote computer system can store the second time synchronization offset in the second data repository.

In this variation, the remote computer system executes the foregoing methods and techniques: to access a set of time synchronization offsets-including the second time synchronization offset-between the first node and the second node; and calculate a composite time synchronization offset between the first node and the second node based on the set of time synchronization offsets (e.g., an average of the set of time synchronization offsets).

Additionally, the remote computer system can execute the foregoing methods and techniques to calculate an estimated position of a target device based on the composite time synchronization offset.

The system can iteratively execute the foregoing methods and techniques according to a predefined time interval (e.g., once per second, once per minute, once per hour).

### 10. Time Synchronization via User Equipment Ensemble

The method S100 includes: accessing a first set of time-of-arrival estimates for a first set of signals transmitted from a set of devices and received at a first node in Block S140; calculating a first average time of arrival at the first node based on an average of the first set of time-of-arrival estimates in Block S144; accessing a second set of time-of-arrival estimates for a second set of signals transmitted from the set of devices and received at a second node in Block S142; calculating a second average time of arrival at the second node based on an average of the second set of time-of-arrival estimates in Block S146; and calculating a first time synchronization offset between the first node and the second node based on the first average time of arrival and the second average time of arrival in Block S148.

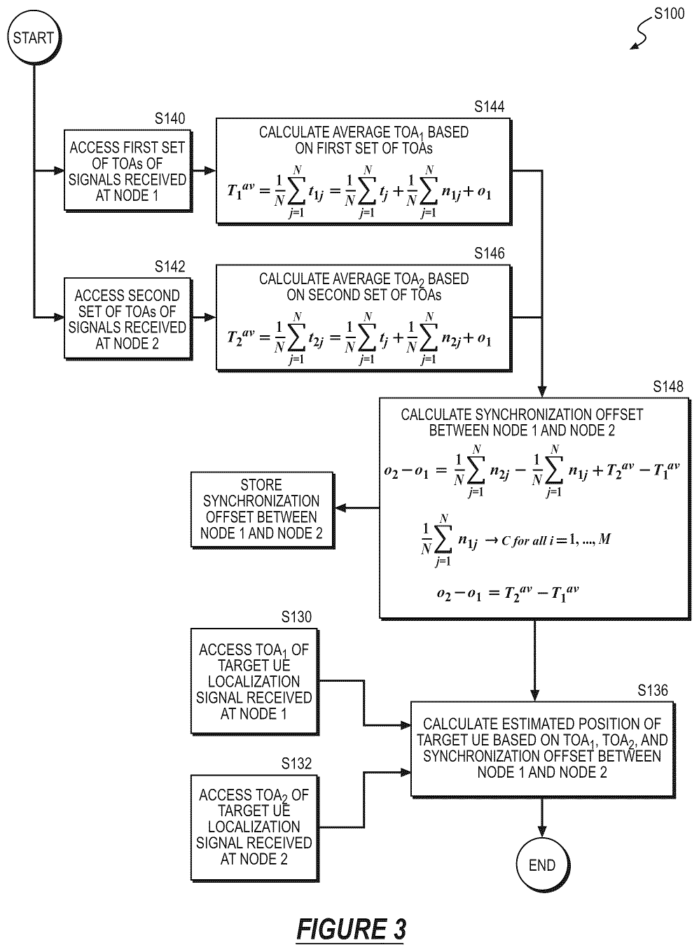

Generally, as shown in FIG. 3 and in Blocks S140, S144, S142, S146, and S148, the system can: receive a set of signals (e.g., communications signals, localization signals, reference signals)—transmitted by a set of devices (e.g., user equipments)—at the first node and the second node; calculate a first average time of arrival of signals received at the first node; calculate a second average time of arrival of signals received at the second node; and calculate a time synchronization offset between the first node and the second node based on the first average time of arrival and the second average time of arrival.

In one variation, the system includes or interfaces with: the set of nodes; the remote computer system; and a set of devices exceeding a threshold quantity of devices (e.g., 30 devices). For example, the set of devices can be uniformly distributed in a geographical area. Additionally, each device, in the set of devices, can be frequency-synchronized with each other device in the set of devices.

In this variation, the system executes similar methods and techniques described above: to instruct the set of devices to transmit a set of reference signals at a set of target times (e.g., t₁, t₂, . . . , t_{N}); to instruct the set of nodes to measure the set of reference signals; to transmit (e.g., broadcast) the set of reference signals from the set of devices at the set of target times; and to calculate time-of-arrival estimates for the set of reference signals received at the set of nodes.

For example, the system can: transmit the set of references signals at the set of target times t₁, t₂, . . . , t_{N}; and calculate a set of time-of-arrival estimates tij for reference signals-transmitted by the set of devices at time j (e.g., j=1, . . . , N)—at a node i (e.g., i=1, . . . , M), wherein:

$${t}_{ij} = {t}_{j} + {n}_{ij} + {o}_{i}$$

In this example: nᵢⱼ represents a propagation time of the reference signals—transmitted from the set of devices at time j—including multipath elements and/or positions of the set of devices; and oᵢ represents a time synchronization offset of node i.

In this variation, the remote computer system: accesses a set of time-of-arrival estimates for a set of signals transmitted from the set of devices and received at the node i; and calculates an average time of arrival

$${T}_{i}^{av}$$

at the node i based on an average of the set of time-of-arrival estimates.

More specifically, the remote computer system can calculate the average time of arrival

$${T}_{i}^{av} ,$$

wherein:

$${T}_{i}^{av} = \frac{1}{N} {\sum }_{j = 1}^{N} {t}_{ij} = \frac{1}{N} {\sum }_{j = 1}^{N} {t}_{j} + \frac{1}{N} {\sum }_{j = 1}^{N} {n}_{ij} + {o}_{i}$$

For example, the remote computer system can: access a first set of time-of-arrival estimates for a first set of signals transmitted from the set of devices and received at a first node in Block S140; and calculate a first average time of arrival

$${T}_{1}^{av}$$

node based on an average of the first set of time-of-arrival estimates in Block S144, wherein:

$${T}_{1}^{av} = \frac{1}{N} {\sum }_{j = 1}^{N} {t}_{1 j} = \frac{1}{N} {\sum }_{j = 1}^{N} {t}_{j} + \frac{1}{N} {\sum }_{j = 1}^{N} {n}_{1 j} + {o}_{1}$$

The remote computer system can execute the foregoing methods and techniques: to access a second set of time-of-arrival estimates for a second set of signals transmitted from the set of devices and received at a second node in Block S142; and to calculate a second average time of arrival

$${T}_{2}^{av}$$

at the second node based on an average of the second set of time-of-arrival estimates in Block S146, wherein:

$${T}_{2}^{av} = \frac{1}{N} {\sum }_{j = 1}^{N} {t}_{2 j} = \frac{1}{N} {\sum }_{j = 1}^{N} {t}_{j} + \frac{1}{N} {\sum }_{j = 1}^{N} {n}_{2 j} + {o}_{2}$$

In this variation, the remote computer system calculates a difference between the second average time of arrival

$${T}_{2}^{av}$$

at the second node and the first average time of arrival

$${T}_{1}^{av}$$

at the first node, wheren:

$${T}_{2}^{av} - {T}_{1}^{av} = \frac{1}{N} {\sum }_{j = 1}^{N} {n}_{2 j} - \frac{1}{N} {\sum }_{j = 1}^{N} {n}_{1 j} + {o}_{2} - {o}_{1}$$

Then, in Block S148, the remote computer system calculates a first (relative) time synchronization offset o₂-o₁ between the first node and the second node, wherein:

$${o}_{2} - {o}_{1} = \frac{1}{N} {\sum }_{j = 1}^{N} {n}_{2 j} - \frac{1}{N} {\sum }_{j = 1}^{N} {n}_{1 j} + {T}_{2}^{av} - {T}_{1}^{av}$$

More specifically, because the set of devices exceed the threshold quantity of devices and are uniformly distributed in the geographical area, the system can characterize the average propagation times of the reference signals as a constant value at any node i (e.g., based on the law of large numbers):

$$\frac{1}{N} {\sum }_{j = 1}^{N} {n}_{i j} \to C for all i = 1 , … , M$$

In this implementation, the multipath component of the propagation time also converges to an average value characteristic of an environment (e.g., the geographical area) in which the measurements are captured (e.g., based on the law of large numbers).

In this implementation, the foregoing equation assumes similar geometry for all nodes. However, even if the node geometries differ, the average propagation delay depends (only) on a relative geometry between the nodes and the device (e.g., a user equipment). Because the set of devices are uniformly distributed in the geographical area, the system can: calculate the average propagation times from the geometry; and subtract the average propagation times from the average time-of-arrival calculations.

Accordingly, in response to detecting a quantity of devices, in the set of devices, exceeding the threshold quantity of devices, the system can calculate the first time synchronization offset o₂−o₁ between the first node and the second node (e.g., the first time synchronization offset for the second node relative to the first node) based on (e.g., corresponding to) the difference between the second average time of arrival

$${T}_{2}^{av}$$

and the first average time of arrival

$${T}_{1}^{av}$$

at the first node, wherein:

$${o}_{2} - {o}_{1} = {T}_{2}^{av} - {T}_{1}^{av}$$

The system can store the first time synchronization offset between the first node and the second node in the second data repository.

Therefore, rather than calculating the first time synchronization offset between the first node and the second node based on a reference signal transmitted by a reference user equipment occupying a known position, the system can calculate the first time synchronization offset between the first node and the second node based on signals transmitted by the set of devices absent information defining positions of the set of devices, thereby improving accuracy of position estimation-based on subsequent signals received at these nodes-without additional burden to the communication network.

The system executes the foregoing methods and techniques for each node in the set of nodes: to access a set of time-of-arrival estimates for a set of signals transmitted from the set of devices and received at the node; to calculate an average time of arrival at the node based on an average of the set of time-of-arrival estimates; to calculate a time synchronization offset between the first node and the node based on a difference between the average time of arrival at the node and the first average time of arrival at the first node; and to store the time synchronization offset in the second data repository.

The system can repeat the foregoing methods and techniques for each pair of nodes in the set of nodes: to calculate a time synchronization offset between the pair of nodes based on average times of arrival of signals transmitted from the set of devices and received at these nodes; and to store the time synchronization offset in the second data repository.

### 10.1 Composite Time Synchronization Offset

In another variation, the system executes the foregoing methods and techniques: to access a first set of time-of-arrival estimates for a first set of signals transmitted from a set of devices and received at a first node; to calculate a first average time of arrival at the first node based on an average of the first set of time-of-arrival estimates; to access a second set of time-of-arrival estimates for a second set of signals transmitted from the set of devices and received at a second node; to calculate a second average time of arrival at the second node based on an average of the second set of time-of-arrival estimates; and to calculate a first time synchronization offset between the first node and the second node based on the first average time of arrival and the second average time of arrival.

Additionally, the system can execute the foregoing methods and techniques: to access a first time-of-arrival estimate for a reference signal transmitted from a reference user equipment and received at the first node; to access a second time-of-arrival estimate for the reference signal received at the second node; to access a first time-of-flight estimate for the reference signal from the reference user equipment to the first node based on a first distance between the reference user equipment and the first node; to access a second time-of-flight estimate for the reference signal from the reference user equipment to the second node based on a second distance between the reference device and the second node; and to calculate a second time synchronization offset between the first node and the second node based on the first time-of-arrival estimate, the second time-of-arrival estimate, the first time-of-flight estimate, and the second time-of-flight estimate.

In this variation, the remote computer system calculates a composite time synchronization offset between the first node and the second node based on the first time synchronization offset and the second time synchronization offset.

For example, the remote computer system can execute similar methods and techniques described above: to access a set of time synchronization offsets-including the first time synchronization offset and the second time synchronization offset-between the first node and the second node; and to calculate the composite time synchronization offset between the first node and the second node based on (e.g., an average of, a median of) the set of time synchronization offsets.

The system can then execute the foregoing methods and techniques: to access a third time-of-arrival estimate for a localization signal transmitted from a target device and received at the first node; to access a fourth time-of-arrival estimate for the localization signal received at the second node; and to calculate an estimated position, in the reference coordinate system, occupied by the target device based on the third time-of-arrival estimate, the fourth time-of-arrival estimate, and the composite time synchronization offset.

The system can iteratively execute the foregoing methods and techniques according to a predefined time interval (e.g., once per second, once per minute, once per hour).

For example, the remote computer system can later: access a third set of time-of-arrival estimates for a third set of signals transmitted from the set of devices—including the target device—and received at the first node; calculate a third average time of arrival at the first node based on an average of the third set of time-of-arrival estimates; access a fourth set of time-of-arrival estimates for a fourth set of signals transmitted from the set of devices and received at the second node; calculate a fourth average time of arrival at the second node based on an average of the fourth set of time-of-arrival estimates; and calculate a third time synchronization offset between the first node and the second node based on the third average time of arrival and the fourth average time of arrival.

In this example, the third set of signals and the fourth set of signals include the localization signal transmitted by the target device; the third set of time-of-arrival estimates includes the third time-of-arrival estimate for the localization signal received at the first node; and the fourth set of time-of-arrival estimates includes the fourth time-of-arrival estimate for the localization signal received at the second node.

The remote computer system can calculate a second composite time synchronization offset between the first node and the second node based on: the first time synchronization offset; the second time synchronization offset; and/or the third synchronization offset.

### 11. Disclaimers

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method comprising:
accessing a first time-of-arrival estimate for a first reference signal received at a first node, the reference signal transmitted from a first reference user equipment;
accessing a second time-of-arrival estimate for the first reference signal received at a second node;
accessing a first distance between the first reference user equipment and the first node;
accessing a second distance between the first reference user equipment and the second node;
calculating a first time-of-flight estimate for the first reference signal from the first reference user equipment to the first node based on the first distance;
calculating a second time-of-flight estimate for the first reference signal from the first reference user equipment to the second node based on the second distance;
calculating a first time synchronization offset between the first node and the second node based on:
the first time-of-arrival estimate;
the second time-of-arrival estimate;
the first time-of-flight estimate; and
the second time-of-flight estimate;
accessing a third time-of-arrival estimate for a localization signal received at the first node, the localization signal transmitted from a target user equipment;
accessing a fourth time-of-arrival estimate for the localization signal received at the second node; and
calculating an estimated position, in a reference coordinate system, occupied by the target user equipment based on:
the third time-of-arrival estimate;
the fourth time-of-arrival estimate; and
the first time synchronization offset.

2. The method of claim 1:
further comprising:
accessing a fifth time-of-arrival estimate for the first reference signal received at a third node;
calculating a third time-of-flight estimate for the first reference signal from the first reference user equipment to the third node based on a third distance between the first reference user equipment and the third node;
calculating a second time synchronization offset between the first node and the third node based on:
the first time-of-arrival estimate;
the fifth time-of-arrival estimate;
the first time-of-flight estimate; and
the third time-of-flight estimate; and
accessing a sixth time-of-arrival estimate for the localization signal received at the third node;
wherein calculating the estimated position occupied by the target user equipment comprises calculating the estimated position occupied by the target user equipment based on:
the third time-of-arrival estimate;
the fourth time-of-arrival estimate;
the sixth time-of-arrival estimate;
the first time synchronization offset; and
the second time synchronization offset.

3. The method of claim 2, wherein calculating the estimated position occupied by the target user equipment comprises:
for the localization signal received at the first node and the second node, calculating a first time difference of arrival based on:
the third time-of-arrival estimate;
the fourth time-of-arrival estimate; and
the first time synchronization offset;
for the localization signal received at the first node and the third node, calculating a second time difference of arrival based on:
the third time-of-arrival estimate;
the sixth time-of-arrival estimate; and
the second time synchronization offset; and
calculating the estimated position occupied by the target user equipment based on the first time difference of arrival and the second time difference of arrival.

4. The method of claim 1:
further comprising:
accessing a fifth time-of-arrival estimate for a second reference signal received at the first node, the second reference signal transmitted from the first reference user equipment;
accessing a sixth time-of-arrival estimate for the second reference signal received at the second node;
calculating a second time synchronization offset between the first node and the second node based on:
the fifth time-of-arrival estimate;
the sixth time-of-arrival estimate;
a third time-of-flight estimate for the second reference signal from the first reference user equipment to the first node based on the first distance between the first reference user equipment and the first node; and
a fourth time-of-flight estimate for the second reference signal from the first reference user equipment to the second node based on the second distance between the first reference user equipment and the second node; and
calculating a first composite time synchronization offset between the first node and the second node based on the first time synchronization offset and the second time synchronization offset; and
wherein calculating the estimated position occupied by the target user equipment comprises calculating the estimated position occupied by the target user equipment based on:
the third time-of-arrival estimate;
the fourth time-of-arrival estimate; and
the first composite time synchronization offset.

5. The method of claim 4, further comprising:
calculating a third time synchronization offset between the first node and the second node based on:
a seventh time-of-arrival estimate for a third reference signal received at the first node, the third reference signal transmitted from the first reference user equipment;
an eighth time-of-arrival estimate for the third reference signal received at the second node;
a fifth time-of-flight estimate for the third reference signal from the first reference user equipment to the first node; and
a sixth time-of-flight estimate for the third reference signal from the first reference user equipment to the second node; and
in response to a difference between the third time synchronization offset and the first composite time synchronization offset exceeding a threshold difference, calculating a second composite time synchronization offset between the first node and the second node based on a set of time synchronization offsets between the first node and the second node, set of time synchronization offsets:
comprising the third time synchronization offset; and
excluding the first time synchronization offset and the second time synchronization offset.

6. The method of claim 1:
further comprising:
accessing a third time-of-arrival estimate for a second reference signal received at the first node, the second reference signal transmitted from a second reference user equipment;
accessing a fourth time-of-arrival estimate for the second reference signal received at the second node;
calculating a fifth time-of-flight estimate for the second reference signal from the second reference user equipment to the first node based on a third distance between the second reference user equipment and the first node;
calculating a sixth time-of-flight estimate for the second reference signal from the second reference user equipment to the second node based on a fourth distance between the second reference user equipment and the second node;
calculating a second time synchronization offset between the first node and the second node based on:
the fifth time-of-arrival estimate;
the sixth time-of-arrival estimate;
the third time-of-flight estimate; and
the fourth time-of-flight estimate; and
calculating a first composite time synchronization offset between the first node and the second node based on the first time synchronization offset and the second time synchronization offset; and
wherein calculating the estimated position comprises calculating the estimated position occupied by the target user equipment based on:
the third time-of-arrival estimate;
the fourth time-of-arrival estimate; and
the first composite time synchronization offset.

7. The method of claim 6, wherein calculating the first composite time synchronization offset comprises:
accessing a set of time synchronization offsets between the first node and the second node, the set of time synchronization offsets comprising the first time synchronization offset and the second time synchronization offset; and
calculating the first composite time synchronization offset based on an average of the set of time synchronization offsets.

8. The method of claim 1:
further comprising:
accessing a first set of time-of-arrival estimates for a first set of signals transmitted from a set of devices and received at the first node;
calculating a first average time of arrival at the first node based on an average of the first set of time-of-arrival estimates;
accessing a second set of time-of-arrival estimates for a second set of signals transmitted from the set of devices and received at the second node;
calculating a second average time of arrival at the second node based on an average of the second set of time-of-arrival estimates;
calculating a second time synchronization offset between the first node and the second node based on:
the first average time of arrival; and
the second average time of arrival; and
calculating a first composite time synchronization offset between the first node and the second node based on the first time synchronization offset and the second time synchronization offset; and
wherein calculating the estimated position occupied by the target user equipment comprises calculating the estimated position occupied by the target user equipment based on:
the third time-of-arrival estimate;
the fourth time-of-arrival estimate; and
the first composite time synchronization offset.

9. The method of claim 8, further comprising:
accessing a third set of time-of-arrival estimates for a third set of signals transmitted from the set of devices and received at the first node, the third set of time-of-arrival estimates comprising the third time-of-arrival estimate for the localization signal transmitted by the target device and received at the first node;
calculating a third average time of arrival at the first node based on an average of the third set of time-of-arrival estimates;
accessing a fourth set of time-of-arrival estimates for a second set of signals transmitted from the set of devices and received at the second node;
calculating a fourth average time of arrival at the second node based on an average of the fourth set of time-of-arrival estimates;
calculating a third time synchronization offset between the first node and the second node based on:
the third average time of arrival; and
the fourth average time of arrival; and
calculating a second composite time synchronization offset between the first node and the second node based on the third synchronization offset.

10. The method of claim 8, wherein calculating the second time synchronization offset comprises calculating the second time synchronization offset based on the first average time of arrival and the second average time of arrival in response to detecting a quantity of devices, in the set of devices, exceeding a threshold quantity.

11. The method of claim 1:
wherein accessing the first distance between the reference user equipment and the first node comprises:
accessing a first set of coordinates, in the reference coordinate system, representing a first position occupied by the first node;
accessing a second set of coordinates, in the reference coordinate system, representing a second position occupied by the first reference user equipment;
calculating the first distance based on a difference between the first position and the second position; and
storing the first distance in a data repository; and
wherein calculating the first time-of-flight estimate comprises calculating the first time-of-flight estimate based on the first distance in response to retrieving the first distance from the data repository.

12. The method of claim 11, wherein accessing the second set of coordinates comprises accessing the second set of coordinates representing the second position occupied by the first reference user equipment based on geographic survey measurements of the reference user equipment.

13. The method of claim 1, wherein accessing the first distance between the reference user equipment and the first node comprises:
accessing a first set of coordinates, in the reference coordinate system, representing a first position occupied by the first node;
accessing a second set of coordinates, in the reference coordinate system, representing a second position occupied by the first reference user equipment at a first time;
accessing a second set of coordinates, in the reference coordinate system, representing a third position occupied by the first reference user equipment at a second time;
calculating a fourth position, in the reference coordinate system, occupied by the first reference user equipment based on the second position and the third position; and
calculating the first distance based on a difference between the first position and the fourth position.

14. The method of claim 1:
further comprising:
receiving a first message from the first node, the first message specifying a set of configuration parameters for the first reference signal;
selecting a set of nodes for the first reference signal, the first set of nodes comprising the first node and the second node;
generating a second message specifying:
the set of configuration parameters; and
a transaction identifier for the second node; and
transmitting the second message to the second node; and
wherein accessing the second time-of-arrival estimate comprises receiving a third message from the second node, the third message specifying the second time-of-arrival estimate and the transaction identifier.

15. The method of claim 14:
wherein generating the second message comprises generating the second message specifying the set of configuration parameters comprising:
a bandwidth for the first reference signal; and
a subcarrier spacing value for the first reference signal; and
wherein accessing the second time-of-arrival estimate comprises accessing the second time-of-arrival estimate for the first reference signal received at the second node according to the set of configuration parameters.

16. A method comprising:
accessing a first set of time-of-arrival estimates for a first set of signals transmitted from a set of devices and received at a first node;
accessing a second set of time-of-arrival estimates for a second set of signals transmitted from the set of devices and received at a second node;
calculating a first average time of arrival at the first node based on an average of the first set of time-of-arrival estimates;
calculating a second average time of arrival at the second node based on an average of the second set of time-of-arrival estimates;
calculating a first time synchronization offset between the first node and the second node based on:
the first average time of arrival; and
the second average time of arrival;
accessing a first time-of-arrival estimate for a localization signal received at the first node, the localization signal transmitted from a target device;
accessing a second time-of-arrival estimate for the localization signal received at the second node; and
calculating an estimated position, in a reference coordinate system, occupied by the target device based on:
the first time-of-arrival estimate;
the second time-of-arrival estimate; and
the first time synchronization offset.

17. The method of claim 16:
further comprising:
accessing a third time-of-arrival estimate for a reference signal received at the first node, the reference signal transmitted from a reference device;
accessing a fourth time-of-arrival estimate for the reference signal received at the second node;
accessing a first time-of-flight estimate for the reference signal from the reference device to the first node based on a first distance between the reference device and the first node;
accessing a second time-of-flight estimate for the reference signal from the reference device to the second node based on a second distance between the reference device and the second node; and
calculating a second time synchronization offset between the first node and the second node based on:
the third time-of-arrival estimate;
the fourth time-of-arrival estimate;
the first time-of-flight estimate; and
the second time-of-flight estimate; and
wherein calculating the estimated position occupied by the target device comprises calculating the estimated position of the target device based on:
the first time-of-arrival estimate;
the second time-of-arrival estimate;
the first time synchronization offset; and
the second time synchronization offset.

18. The method of claim 16, wherein calculating the first time synchronization offset comprises calculating the first time synchronization offset based on the first average time of arrival and the second average time of arrival in response to detecting a quantity of devices, in the set of devices, exceeding a threshold quantity.

19. A method comprising:
accessing a first time-of-arrival estimate for a reference signal received at a first node, the reference signal transmitted from a reference device;
accessing a second time-of-arrival estimate for the reference signal received at a second node;
accessing a first time-of-flight estimate for the reference signal from the reference device to the first node based on a first distance between the reference device and the first node;
accessing a second time-of-flight estimate for the reference signal from the reference device to the second node based on a second distance between the reference device and the second node; and
calculating a first time synchronization offset between the first node and the second node based on:
the first time-of-arrival estimate;
the second time-of-arrival estimate;
the first time-of-flight estimate; and
the second time-of-flight estimate.

20. The method of claim 19, further comprising:
accessing a third time-of-arrival estimate for a localization signal received at the first node, the localization signal transmitted from a target device;
accessing a fourth time-of-arrival estimate for the localization signal received at the second node; and
calculating an estimated position, in a reference coordinate system, occupied by the target device based on:
the third time-of-arrival estimate;
the fourth time-of-arrival estimate; and
the first time synchronization offset.
